(19) United States
(12) Patent Application Publication
(10) Pub. No.: US 2019/0014764 A1
(43) Pub. Date: Jan. 17, 2019

(54) INSIDE COVER LOCK MECHANISM

(71) Applicant: W.C. Bradley/Zebco Holdings, Inc., Tulsa, OK (US)

(72) Inventor: Hyunkyu Kim, Broken Arrow, OK (US)

(21) Appl. No.: 16/032,650

(22) Filed: Jul. 11, 2018

Related U.S. Application Data
(60) Provisional application No. 62/531,200, filed on Jul. 11, 2017.

(51) Int. Cl. A01K 89/01

(52) U.S. Cl. CPC A01K 89/01125; A01K 89/0113

(57) ABSTRACT

A fishing reel has a frame and a lock ring that engages locking structures on the frame. A cover assembly defines cover locking structures for locking engagement with outside lock ring locking structures on the lock ring. A brake spool cover is secured to an inside surface of the cover assembly. A brake ring support is adjacent to the inner side of the brake spool cover. The brake ring support is axially positionable with respect to the brake spool cover and defines a plurality of guide holes that receive prongs defined by a slide spring retainer.

### CROSS REFERENCE TO RELATED APPLICATIONS

This application claims the priority of U.S. Provisional Patent Application No. 62/531,200 entitled “INSIDE COVER LOCK MECHANISM,” filed Jul. 11, 2017, the contents of which are hereby incorporated by reference.

### FIELD OF THE INVENTION

The invention relates to fishing reels. More particularly, the invention relates to an inside cover lock mechanism for a fishing reel.

### BACKGROUND OF THE INVENTION

Many baitcast-type fishing reels are available on the market today. Typical baitcast reel construction includes a spool, which is rotatable to retrieve line onto the fishing reel, and a crank handle that imparts rotation to the spool through a drive train in a retrieve mode. By operating an actuator, the drive train may be disengaged to place the fishing reel in a cast mode. In cast mode, the spool is “free-wheeling”. When casting, the weight of the bait causes the line to pay out and the spool to initially rotate at a relatively high speed. An experienced user can manually feather the rotating spool with a thumb to prevent line tangling in the spool region. However, even the experienced user may create a condition wherein the line payout speed and rotational speed of the spool differ, resulting in “backlashes” and “bird nests” in the line supply.

At times this condition can be easily remedied by the user. However, in some cases, it is most convenient for the user to completely separate the spool from the remainder of the reel to access the tangled line.

In some baitcast reel designs, the side cover assembly on the side opposite to the crank handle, i.e., on the “palm side”, can be removed by releasing a series of long bolts which are directed laterally through the side cover assembly and into a frame supporting the reel operating mechanism and the side cover assembly. Aside from the inconvenience of having to loosen and later re-tighten the plurality of bolts, the user risks losing the bolts, particularly when the disassembly is carried out in a boat.

More recently, some baitcast reels provide a mechanism by which a lever may be manipulated to allow a cover assembly to be rotated with regard to the reel frame to release the cover assembly from the reel frame. Problems experienced with this type of construction include galvanic corrosion, wherein metal used in the construction of the reel and side cover assembly, e.g., aluminum to aluminum, or zinc to aluminum, may interact with one another. The result can be a cover assembly that resists rotation, a lever that freezes in place, or pins that are frozen and lock up.

### SUMMARY OF THE INVENTION

A fishing reel of the invention includes a spool assembly and a frame. The frame has a palm side and a gear side. The palm side of the frame defines a spool orifice for allowing entry of the spool assembly so that the spool assembly may be located between the palm side and the gear side of the frame.

A plurality of locking member receiving structures surround the spool orifice. Each locking member receiving structure has a height, a length, and a receiving side. The receiving side of each locking member defines a locking member receiving indentation. The locking member receiving indentation has a length that is less than the length of the locking member receiving structure.

A palm side cover assembly is received on the palm side of the frame. The palm side cover assembly defines an inside surface and a control dial orifice.

A brake spool cover is affixed to the inside surface of the palm side cover assembly. The brake spool cover includes an outer ring, a center member and legs that span between the outer ring and the center member. The outer ring defines a plurality of outwardly extending tabs.

A brake ring support has a plurality of control dial interfacing members that extend from the brake ring support between the legs of the brake spool cover. A brake ring is received in the brake ring support.

A control dial is received in the control dial orifice of the palm side cover assembly. The control dial defines a camming surface that engages the control dial interfacing members of the brake ring support for axially displacing the brake ring support and the attached brake ring.

A brake ring slide spring retainer defines a plurality of prongs that extend towards the palm side cover assembly. Slide springs on the prongs of the brake ring slide spring retainer are provided for biasing the brake ring support towards the palm side cover assembly against the camming surface of the control dial.

A lock ring has a palm side, a gear side and a height between the palm side and the gear side. The lock ring has an inside surface and an outside surface. The outside surface defines a plurality of frame locking members.

The frame locking members have a height, a width and an engaging side. The engaging side defines a cutout that defines a horizontal locking member sized to be received in the locking member receiving indentation of the locking member receiving structures of the palm side of the frame when the lock ring is rotated in a first (e.g., counterclockwise) direction.

The inside surface of the lock ring defining tab receiving channels run from the palm side to the gear side of the lock ring. The inside surface proximate the gear side of the lock ring further defines a tab receiving area having a height that is less than the height of the lock ring. The tab receiving area is in communication with the tab receiving channel, wherein a locking lever is provided to facilitate ease of rotation of the lock ring.

A first lock ring retaining tab and a second lock ring retaining tab are affixed to the palm side of the frame for securing the lock ring to the frame.

The palm side cover assembly and attached brake spool cover is attached to the frame by locating the outwardly extending tabs in the tab receiving channels of the lock ring and rotating the lock ring in the first direction (e.g., counterclockwise) for moving the outwardly extending tabs of the brake spool cover into the tab receiving area of the lock ring, which prevents axial movement of the outwardly extending tabs until the outwardly extending tab is again positioned in the tab receiving channel by rotating the lock ring in a second direction (e.g., clockwise) with the locking lever.

An advantage of the reel of the invention is that the reel is configured to secure tabs of the reel cover with a lever assembly constructed of a non-corrosive material to facilitate reliability and ease of removal of the reel cover. In particular the lock ring may be constructed of a polymer or thermoplastic such as polyphenylene sulfide for preventing contact of the palm side cover assembly with the frame, thereby eliminating potential galvanic corrosion due to, e.g., aluminum to aluminum contact.

In one embodiment, the fishing reel comprises a frame having a first side, the first side defining a plurality of frame locking structures, a lock ring having an inside surface and an outside surface, the inside surface defining a plurality of inside lock ring locking structures for locking communication with the frame locking structures, the outside surface defining outside lock ring locking structures, and a cover assembly defining an inside surface, the inside surface defining cover locking structures for locking engagement with the outside lock ring locking structures. The inside surface of the lock ring is affixed to the first side of the frame. The inside surface of the cover assembly is affixed to the outside surface of the lock ring. In one embodiment, the lock ring is comprised of a non-corrosive material. In one embodiment, the non-corrosive material is a thermopolymer. In one embodiment, the thermopolymer is polyphenylene sulfide. In one embodiment, one of the frame locking structures and the inside lock ring locking structures has a height, a length, and a receiving side. The receiving side defines a locking member receiving indentation for receiving a horizontal locking member. In one embodiment, one of the frame locking structures and the inside lock ring locking structures is locking members, and the locking members have a height, a width and an engaging side, the engaging side defining a horizontal member sized to be received in a locking member receiving indentation of the other of the frame locking structures and the inside lock ring locking structure when the lock ring is rotated in a first direction. In one embodiment, the inside surface of the lock ring defines tab receiving channels that run from the outside surface to the inside surface of the lock ring, the inside surface further defining a tab receiving area in communication with the tab receiving channels. In one embodiment, the lock ring includes a locking lever to facilitate ease of rotation of the lock ring. In one embodiment, a first lock ring retaining tab and a second lock ring retaining tab are affixed to the first side of the frame for securing the lock ring to the frame. In one embodiment, a brake spool cover is affixed to the inside surface of the cover assembly, the brake spool cover includes an outer ring, the outer ring defining a plurality of outwardly extending tabs. In one embodiment, the lock ring defines tab receiving channels, and the cover assembly and attached brake spool cover are attached to the frame by locating the outwardly extending tabs in the tab receiving channels of the lock ring. Rotation of the lock ring in a first direction moves the outwardly extending tabs of the brake spool cover into the tab receiving channels of the lock ring for preventing axial movement of the outwardly extending tabs until the outwardly extending tabs are positioned in the tab receiving channels by rotating the lock ring in a second direction. In one embodiment, the brake spool cover is comprised of a center member and legs that span between the outer ring and the center member. In one embodiment, the reel includes a brake ring support having a plurality of control dial interfacing members that extend from the brake ring support between the legs of the brake spool cover, and a brake ring is received in the brake ring support. In one embodiment, the cover assembly further defines a control dial orifice. In one embodiment, the reel includes a control dial received in the control dial orifice of the cover assembly, the control dial defining a camming surface that engages the control dial interfacing members of the brake ring support for axially displacing the brake ring support and the attached brake ring. In one embodiment, the brake ring support defines a plurality of guide holes and the reel further includes a slide spring retainer defining a plurality of prongs that extend towards the cover assembly, the prongs received in the guide holes of the brake ring support. In one embodiment, the slide springs are received on the prongs of the slide spring retainer for biasing the brake ring support towards the cover assembly against the camming surface of the control dial. In one embodiment, guide holes of the brake ring support are defined by the central dial interfacing members of the brake ring support. Aspects of the invention may include each of the above listed components or selected components from the above listed components singularly or in combination.

For example, the invention may comprise a lock ring having an inside surface and an outside surface, the inside surface defining a plurality of inside lock ring locking structures for locking communication with the frame locking structures, the outside surface defining outside lock ring locking structures, and a cover assembly defining an inside surface, the inside surface defining cover locking structures for locking engagement with the outside lock ring locking structures. The inside surface of the lock ring is affixed to the first side of the frame. The inside surface of the cover assembly is affixed to the outside surface of the lock ring. In one embodiment, the lock ring is comprised of a non-corrosive material. In one embodiment, the non-corrosive material is a thermopolymer. In one embodiment, the thermopolymer is polyphenylene sulfide. In one embodiment, one of the frame locking structures and the inside lock ring locking structures has a height, a length, and a receiving side. The receiving side defines a locking member receiving indentation for receiving a horizontal locking member. In one embodiment, one of the frame locking structures and the inside lock ring locking structures is locking members, and the locking members have a height, a width and an engaging side, the engaging side defining a horizontal member sized to be received in a locking member receiving indentation of the other of the frame locking structures and the inside lock ring locking structure when the lock ring is rotated in a first direction. In one embodiment, the inside surface of the lock ring defines tab receiving channels that run from the outside surface to the inside surface of the lock ring, the inside surface further defining a tab receiving area in communication with the tab receiving channels. In one embodiment, the lock ring includes a locking lever to facilitate ease of rotation of the lock ring. In one embodiment, a first lock ring retaining tab and a second lock ring retaining tab are affixed to the first side of the frame for securing the lock ring to the frame. In one embodiment, the lock ring defines tab receiving channels, and a cover assembly and attached brake spool cover are attached to the frame by locating the outwardly extending tabs in the tab receiving channels of the lock ring. Rotation of the lock ring in a first direction moves the outwardly extending tabs of the brake spool cover into the tab receiving channels of the lock ring for preventing axial movement of the outwardly extending tabs until the outwardly extending tabs are positioned in the tab receiving channels by rotating the lock ring in a second direction.

As another example, the invention may comprise a brake spool cover that is affixed to the inside surface of the cover assembly, the brake spool cover including an outer ring, the outer ring defining a plurality of outwardly extending tabs. In one embodiment, the brake spool cover is comprised of a center member and legs that span between the outer ring and the center member.

In a further example, the invention comprises a brake ring support that defines a plurality of guide holes and the reel further includes a slide spring retainer defining a plurality of prongs that extend towards the cover assembly, the prongs received in the guide holes of the brake ring support. In one embodiment, the slide springs are received on the prongs of the slide spring retainer for biasing the brake ring support towards the cover assembly against the camming surface of the control dial. In one embodiment, guide holes of the brake ring support are defined by the central dial interfacing members of the brake ring support. The brake ring support may have a plurality of control dial interfacing members that extend from the brake ring support between the legs of the brake spool cover, and a brake ring is received in the brake ring support. In one embodiment, the cover assembly further defines a control dial orifice.

The fishing reel of the invention may comprise a frame having a first side, the first side defining a plurality of frame locking structures, a cover assembly having an inside surface and an outside surface, the inside surface adjacent the first side of the frame, a brake spool cover secured to the inside surface of the cover assembly, the brake spool cover having an inner side, the brake ring support adjacent the inner side of the brake spool cover, the brake ring support axially positionable with regard to the brake spool cover, the brake ring support defining a plurality of guide holes, and a slide spring retainer defining prongs that extend towards the cover assembly, the prongs received in the guide holes of the brake ring support. In one embodiment, the cover assembly defines a control dial orifice, the brake ring support defining control dial interfacing members, and the reel further comprising a control dial received in the control dial orifice of the cover assembly, the control dial defining a camming surface that engages the control dial interfacing members of the brake ring support for axially displacing the brake ring support and an attached brake ring. In one embodiment, the reel further includes slide springs on the prongs of the slide spring retainer for biasing the brake ring support towards the cover assembly against the camming surface of the control dial. In one embodiment, the guide holes of the brake ring support are defined by the control dial interfacing members of the brake ring support. In one embodiment, the reel further includes a lock ring having an inner surface, an outer surface, and a width between the inner surface and the outer surface, the inner surface defining a plurality of inside lock ring locking structures for locking communication with the frame locking structures, the outer surface defining outer lock ring locking structures. In one embodiment, the outside surface of the cover assembly defines cover locking structures for locking engagement with the outer lock ring locking structures of the lock ring. In one embodiment, the inner surface of the lock ring is affixed to the first side of the frame, and the inside surface of the cover assembly is affixed to the outer surface of the lock ring. In one embodiment, the lock ring is comprised of a non-corrosive material. In one embodiment, one of the frame locking structures and the inside lock ring locking structures has a height, a length, and a receiving side, wherein the receiving side defines a locking member receiving indentation for receiving a horizontal locking member. In one embodiment, one of the frame locking structures and the inside lock ring locking structures is locking members having an height, a width and an engaging side, the engaging side defining a horizontal member sized to be received in a locking member receiving indentation of the other of the frame locking structures and the inside lock ring locking structures when the lock ring is rotated in a first direction. In one embodiment, the inner surface of the lock ring defines tab receiving channels that run from the outer surface to the inner surface of the lock ring, the inner surface further defining a tab receiving area in communication with the tab receiving channels. In one embodiment, the lock ring includes a locking lever to facilitate ease of rotation of the lock ring. In one embodiment, the reel further includes a first lock ring retaining tab and a second lock ring retaining tab affixed to the first side of the frame for securing the lock ring to the frame. Aspects of the invention may include each of the above listed components or selected components from the above listed components singularly or in combination.

For example, the invention may comprise a cover assembly having an inside surface and an outside surface, the inside surface adjacent the first side of a frame. In one embodiment, the cover assembly defines a control dial orifice, the brake ring support defining control dial interfacing members, and the reel further comprising a control dial received in the control dial orifice of the cover assembly, the control dial defining a camming surface that engages the control dial interfacing members of the brake ring support for axially displacing the brake ring support and an attached brake ring.

In another example, the invention may comprise a brake spool cover secured to an inside surface of a cover assembly, the brake spool cover having an inner side.

In another example, the invention may comprise a brake ring support adjacent an inner side of a brake spool cover, the brake ring support axially positionable with regard to the brake spool cover, the brake ring support defining a plurality of guide holes.

In another example, the invention may comprise a slide spring retainer that defines prongs that extend towards a cover assembly, the prongs received in guide holes of a brake ring support. In one embodiment, the reel further includes slide springs on the prongs of the slide spring retainer for biasing the brake ring support towards the cover assembly against the camming surface of the control dial.

### BRIEF DESCRIPTION OF THE DRAWINGS

FIG. 1 is an exploded perspective view of a reel of the invention.

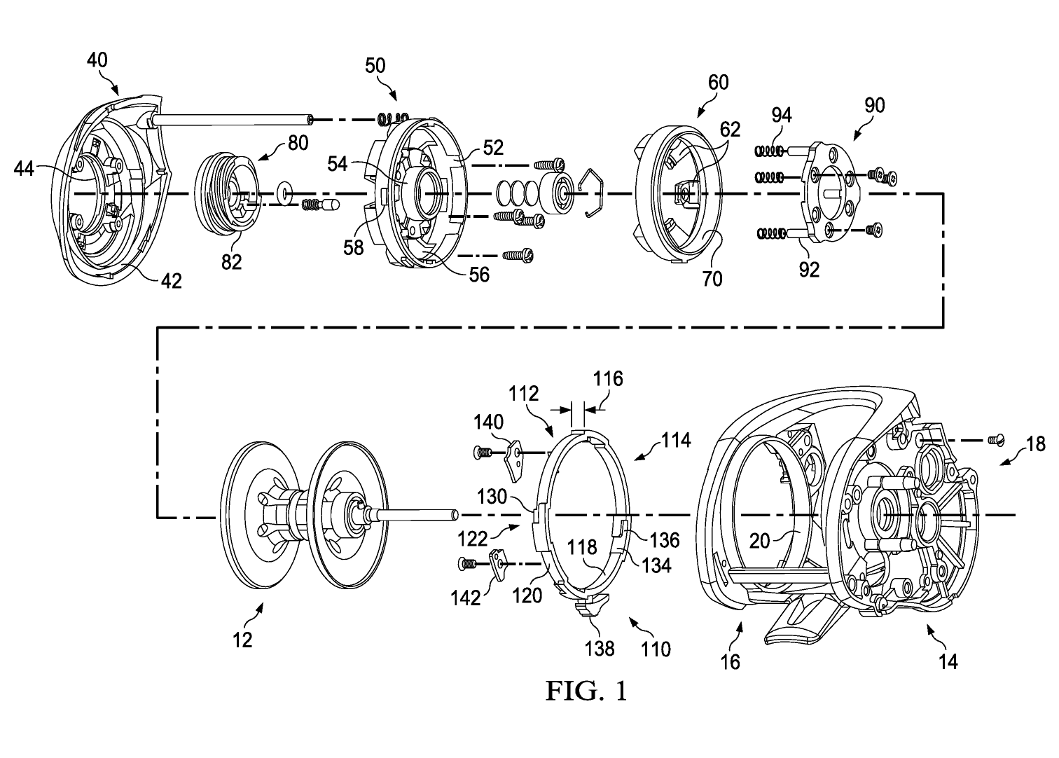

FIG. 2 is an enlarged exploded perspective view of the reel of FIG. 1.

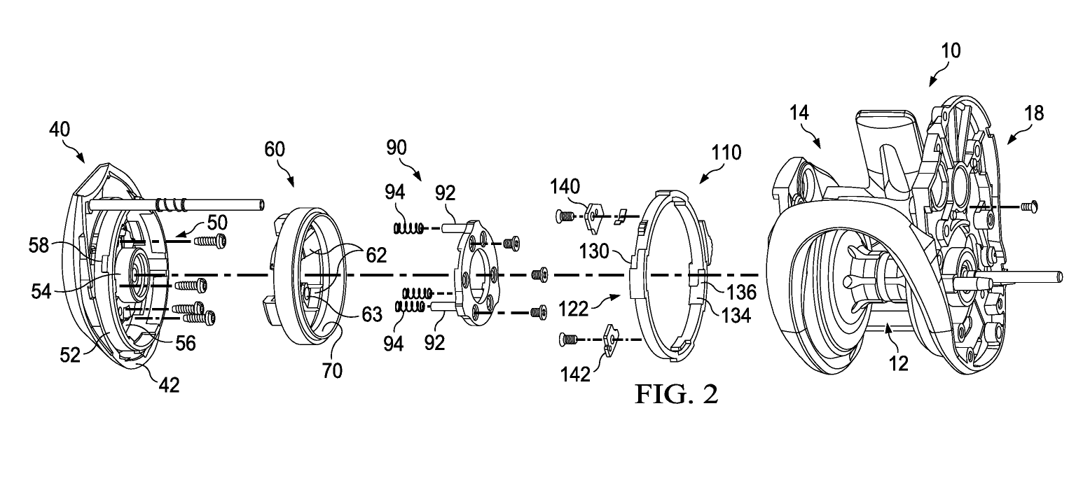

FIG. 3 is an enlarged exploded perspective view of the reel of FIG. 1.

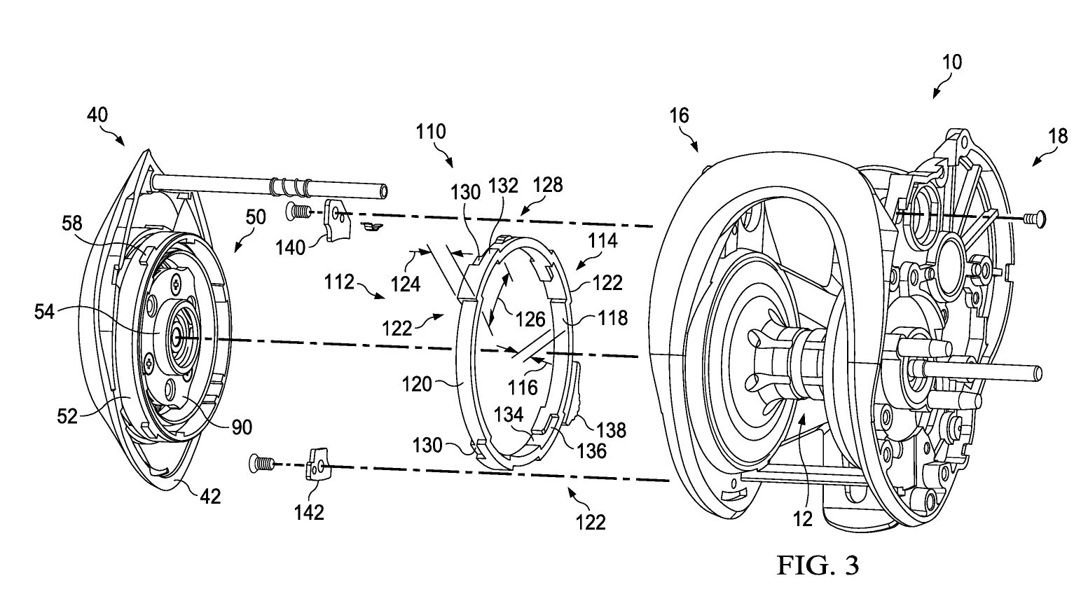

FIG. 4 is an enlarged exploded perspective view of the brake spool cover, lock ring, and frame of the reel of FIG. 1.

FIG. 5 is an enlarged perspective view of the frame with an affixed lock ring of the reel of FIG. 1.

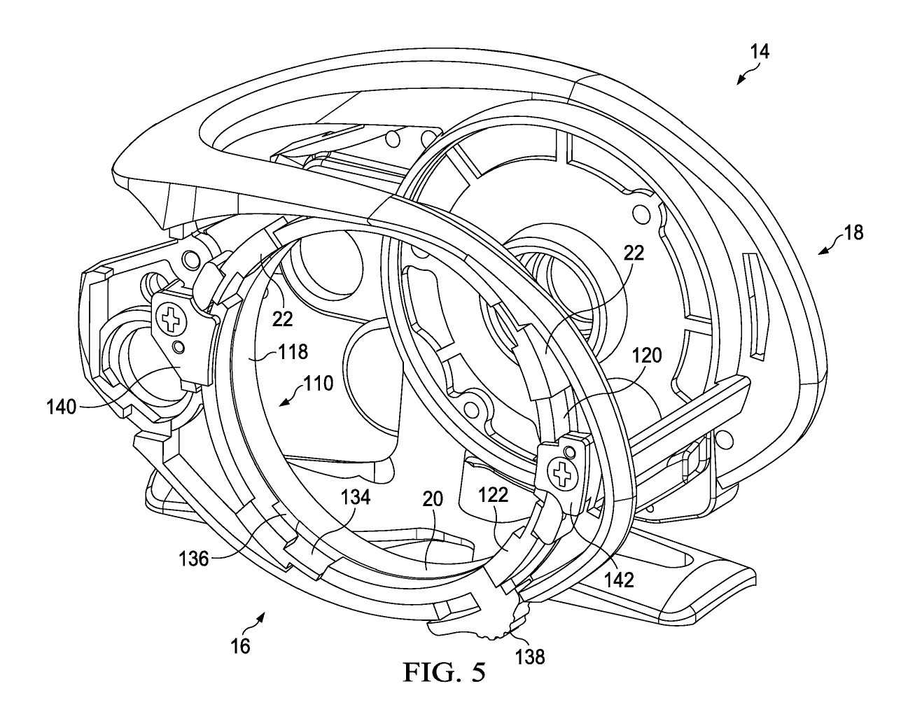

FIG. 6 is an enlarged perspective view of the frame of the reel of FIG. 1 when the lock ring is in an “on” position.

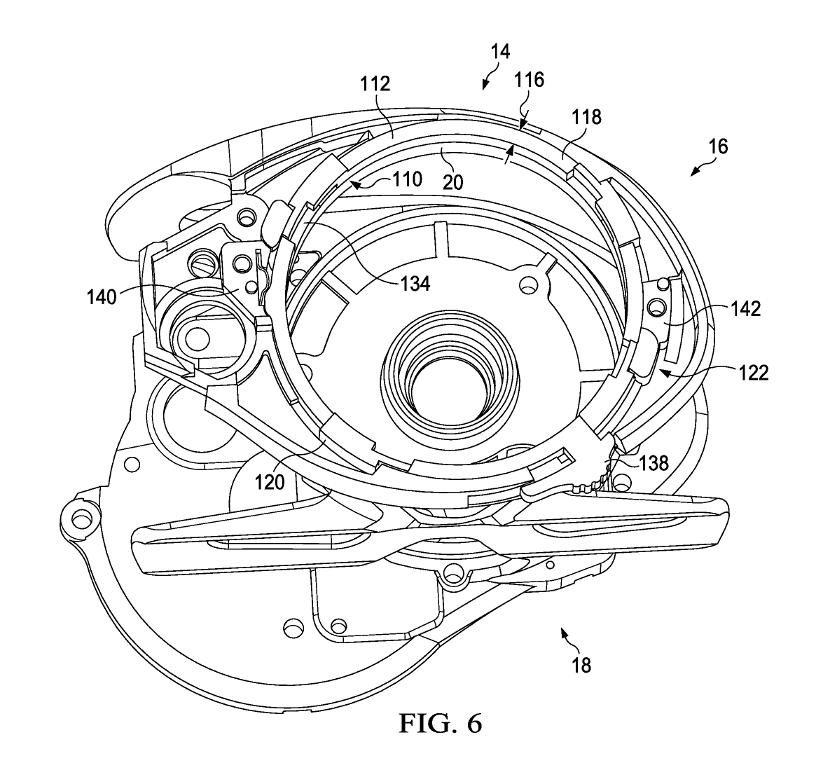

FIG. 7 is an enlarged perspective view of the frame of the reel of FIG. 1 when the lock ring is in an “off” position.

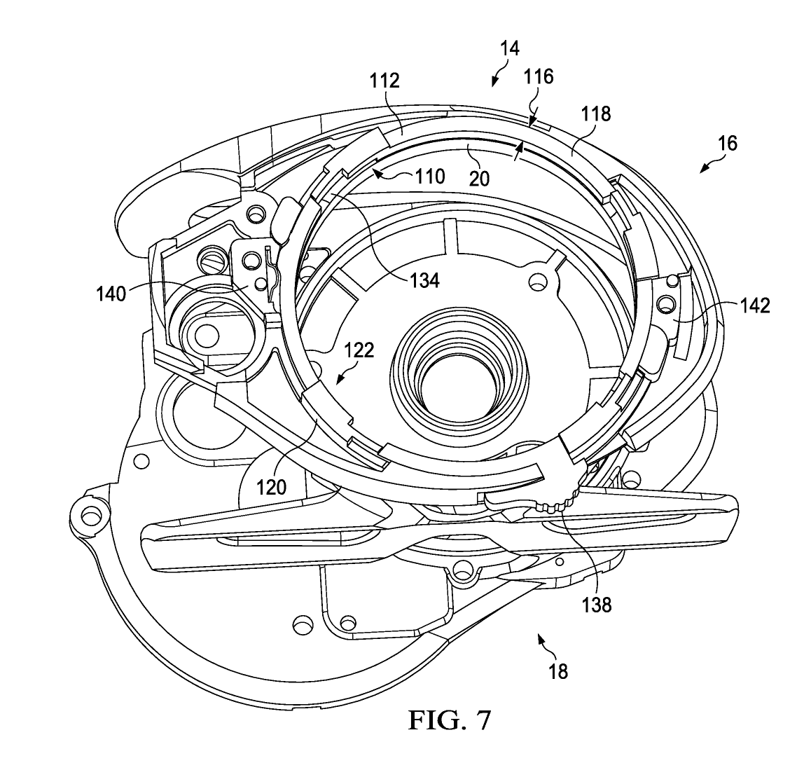

FIG. 8 is a plan view of the frame and lock ring shown securing the brake spool cover to the frame in a locked position.

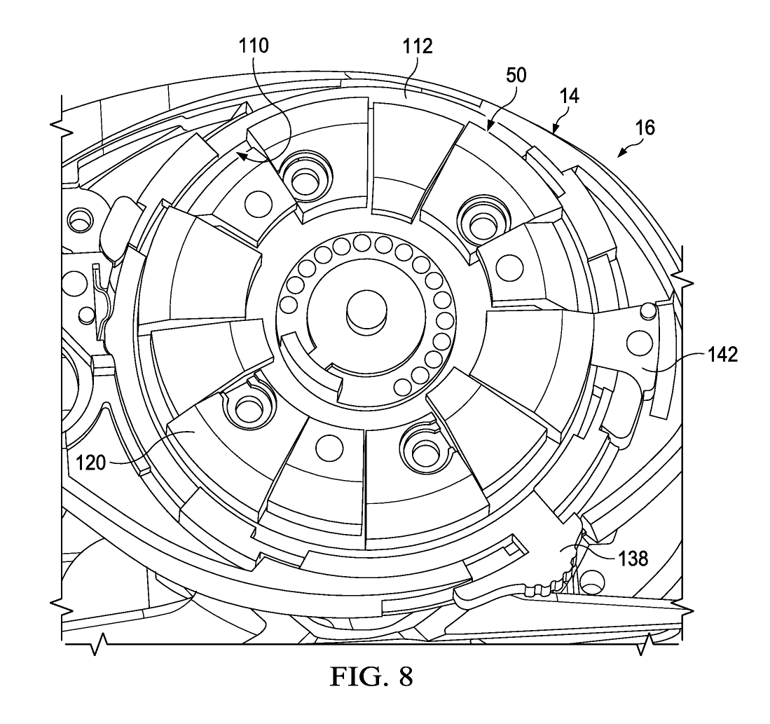

FIG. 9 is a plan view of the frame and lock ring shown wherein the lock ring is in an unlocked position.

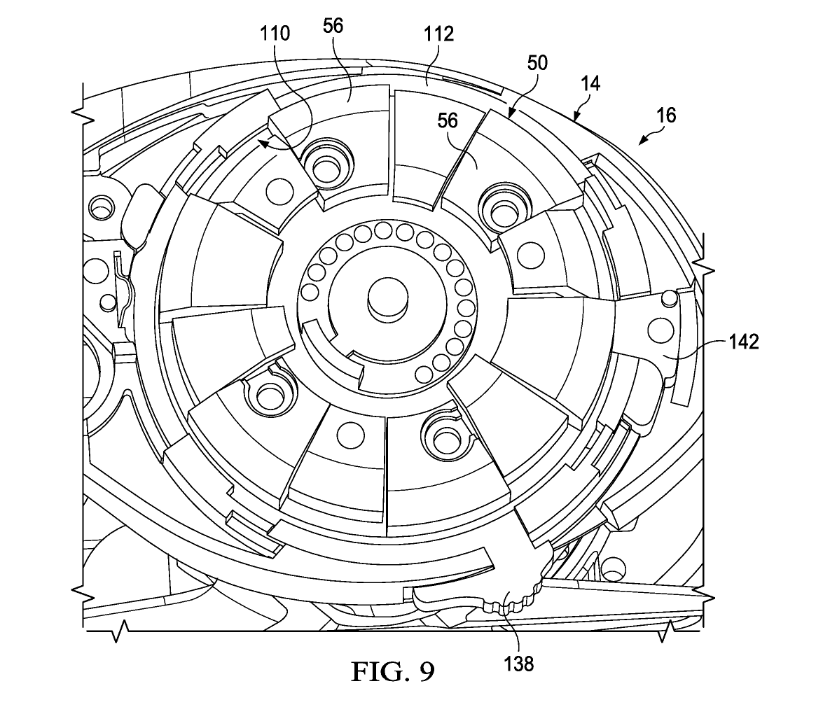

FIG. 10 is an enlarged perspective view of a portion of the lock ring.

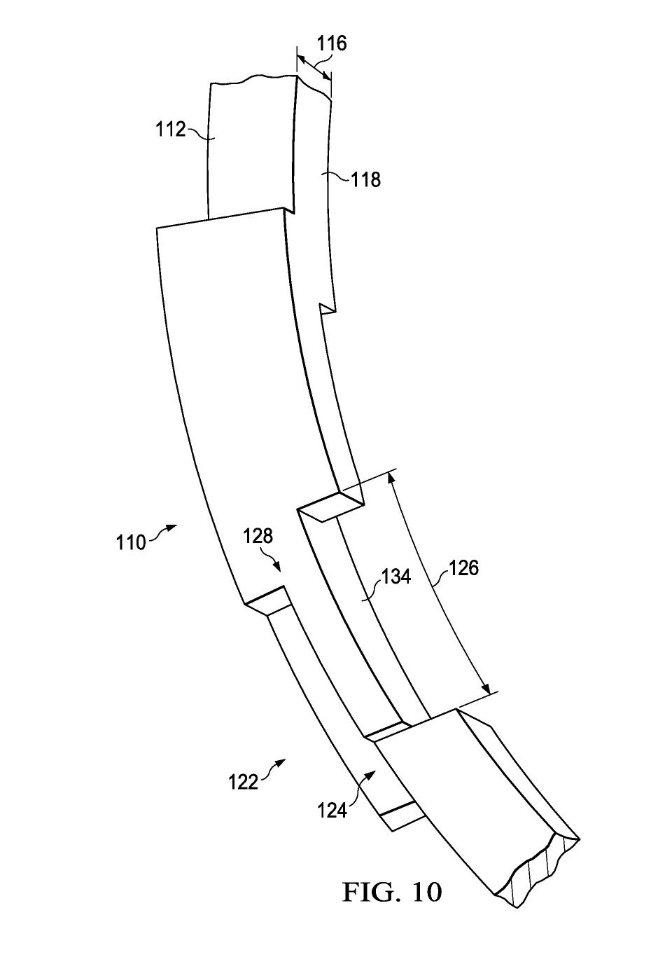

### DETAILED DESCRIPTION OF THE PREFERRED EMBODIMENTS

The fishing reel of the invention is designated generally 10. Fishing reel 10 includes spool assembly 12 and frame 14. Frame 14 has palm side 16 and gear side 18. Palm side 16 defines spool orifice 20 for locating spool assembly 12 between palm side 16 and gear side 18 of frame 14.

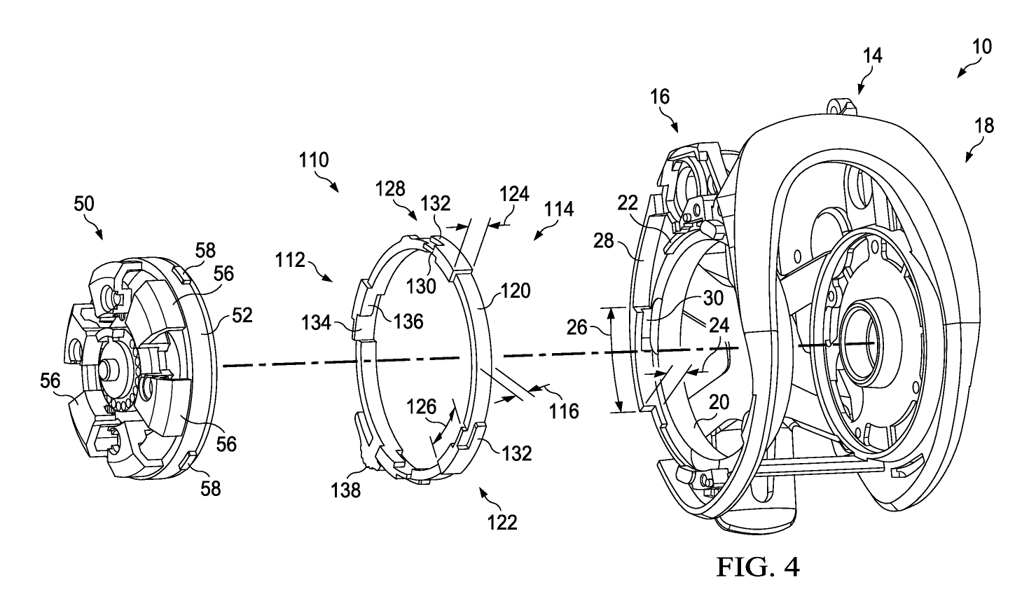

A plurality of locking member receiving structures 22 (FIG. 4) surround spool orifice 20. Each locking member receiving structure 22 has a height 24, a length 26, and a receiving side 28. Receiving side 28 defines locking member receiving indentation 30 having a length less than length 26 of locking member receiving structure 22.

Palm side cover assembly 40 is for locating on palm side 16 of frame 14. Palm side cover assembly 40 defines inside surface 42 and control dial orifice 44.

Brake spool cover 50 is affixed to inside surface 42 of palm side cover assembly 40. Brake spool cover 50 has outer ring 52, center member 54, and legs 56 that span between outer ring 52 and center member 54. Outer ring 52 defines a plurality of outwardly extending tabs 58.

Brake ring support 60 has a plurality of control dial interfacing members 62 that extend from brake ring support 60 between legs 56 of brake spool cover 50.

Brake ring 70 is received in brake ring support 60.

Control dial 80 is received in control dial orifice 44 of palm side cover assembly 40. Control dial 80 defines camming surface 82 that engages control dial interfacing member 62 of brake ring support 60 for axially displacing brake ring support 60 and attached brake ring 70. Control dial interfacing members 62 define guide holes 63.

Brake ring slide spring retainer 90 defines a plurality of prongs 92 that extend toward palm side cover assembly 40. Prongs 92 are received in guide holes 63 of control brake ring support 60.

Slide springs 94 are located on prongs 92 of brake ring slide spring retainer 90 and engage control dial interfacing members 62 for biasing brake ring support 60 towards palm side cover assembly 40 and control dial interfacing member 62 of brake ring support 60 against camming surfaces 82 of control dial 80. The assembly of prongs 92 received in guide holes 63 and the location of slide springs 94 on prongs 92 facilitate proper alignment of the brake ring slide spring retainer 90 and assists in the elimination of spring seizing that could result from tilting of brake ring slide spring retainer 90.

Lock ring 110 has palm side 112, gear side 114, and height 116 defined by a distance between palm side 112 and gear side 114. Lock ring 110 has inside surface 118 and outside surface 120. Outside surface 120 defines a plurality of frame locking members 122.

Frame locking members 122 have a height 124, a length 126, and an engaging side 128. Engaging side 128 defines cutout 130 that defines horizontal locking member 132. Horizontal locking member 132 is sized to be received in locking member receiving indentation 30 of locking member receiving structure 32 on palm side 16 of frame 12 when lock ring 110 is rotated in a first, e.g., counterclockwise, direction.

Inside surface 118 of lock ring 110 defines a plurality of tab receiving channels 134 that run from palm side 112 to gear side 114 of lock ring 110. Inside surface 118 proximate to gear side 114 of lock ring 110 further defines tab receiving area 136 having a height that is less than height 116 of lock ring 110. Tab receiving area 136 is in communication with tab receiving channel 134. Locking lever 138 is provided to facilitate ease of rotation of lock ring 110 by a user.

First lock ring retaining tab 140 and second lock ring retaining tab 142 are affixed to palm side 16 of frame 14 for securing lock ring 110 to frame 14.

Palm side cover assembly 40 and attached brake spool cover 50 are secured to frame 14 by locating tabs 58 of brake spool cover 50 in tab receiving channels 134 of lock ring 110 and rotating lock ring 110 in a first, e.g., counterclockwise, direction for moving tab 58 of brake spool cover 50 into tab receiving area 136. By locating tab 58 in tab receiving area 136, axial movement of tab 58 and attached palm side cover assembly 40 until tab 58 is again positioned in tab receiving channel 134 by rotating lock ring 110 in a second, e.g., clockwise, direction, preferably by manipulating locking lever 138.

Although exemplary embodiments of locking structures and locking structure interfaces are described herein, it should be understood that the particular locking structures described on frame 14, lock ring 110 and palm side cover assembly 40 could be reversed so long as locking interaction between adjacent components are retained.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A fishing reel comprising:
a frame having a first side, said first side defining a plurality of frame locking structures;
a lock ring having an inside surface and an outside surface, said inside surface defining a plurality of inside lock ring locking structures for locking communication with said frame locking structures, said outside surface defining outside lock ring locking structures;
a cover assembly defining an inside surface, said inside surface defining cover locking structures for locking engagement with said outside lock ring locking structures;
wherein said inside surface of said lock ring is affixed to said first side of said frame;
wherein said inside surface of said cover assembly is affixed to said outside surface of said lock ring.

2. The fishing reel according to claim 1 wherein:
said lock ring is comprised of a non-corrosive material.

3. The fishing reel according to claim 2 wherein:
said non-corrosive material is a thermopolymer.

4. The fishing reel according to claim 3 wherein:
said thermopolymer is polyphenylene sulfide.

5. The fishing reel according to claim 1 wherein:
one of said frame locking structures and said inside lock ring locking structures has a height, a length, and a receiving side, wherein said receiving side defines a locking member receiving indentation for receiving a horizontal locking member.

6. The fishing reel according to claim 1 wherein:
one of said frame locking structures and said inside lock ring locking structures is locking members; and
said locking members having an height, a width and an engaging side, said engaging side defining a horizontal member sized to be received in a locking member receiving indentation of the other of said frame locking structures and said inside lock ring locking structure when said lock ring is rotated in a first direction.

7. The fishing reel according to claim 1 wherein:
said inside surface of said lock ring defines tab receiving channels that run from said outside surface to said inside surface of said lock ring, said inside surface further defining a tab receiving area in communication with said tab receiving channels.

8. The fishing reel of claim 1 wherein:
said lock ring includes a locking lever to facilitate ease of rotation of said lock ring.

9. The fishing reel according to claim 1 further comprising:
a first lock ring retaining tab and a second lock ring retaining tab affixed to said first side of said frame for securing said lock ring to said frame.

10. The fishing reel according to claim 1 wherein:
a brake spool cover is affixed to said inside surface of said cover assembly, said brake spool cover comprised of an outer ring, said outer ring defining a plurality of outwardly extending tabs.

11. The fishing reel according to claim 10 wherein:
said lock ring defines tab receiving channels;
said cover assembly and attached brake spool cover are attached to said frame by locating said outwardly extending tabs in said tab receiving channels of said lock ring;
wherein rotation of said lock ring in a first direction moves said outwardly extending tabs of said brake spool cover into said tab receiving channels of said lock ring for preventing axial movement of said outwardly extending tabs until said outwardly extending tabs are positioned in said tab receiving channels by rotating said lock ring in a second direction.

12. The fishing reel according to claim 10 wherein:
said brake spool cover is comprised of a center member and legs that span between said outer ring and said center member.

13. The fishing reel according to claim 12 further comprising:
a brake ring support having a plurality of control dial interfacing members that extend from said brake ring support between said legs of said brake spool cover;
a brake ring received in said brake ring support.

14. The fishing reel according to claim 13 wherein:
said cover assembly further defines a control dial orifice.

15. The fishing reel according to claim 14 further comprising:
a control dial received in said control dial orifice of said cover assembly, said control dial defining a camming surface that engages said control dial interfacing members of said brake ring support for axially displacing said brake ring support and said attached brake ring.

16. The fishing reel according to claim 15 wherein:
said brake ring support defines a plurality of guide holes; and further comprising:
a slide spring retainer defining a plurality of prongs that extend towards said cover assembly, said prongs received in said guide holes of said brake ring support.

17. The fishing reel according to claim 16 further comprising:
slide springs on said prongs of said slide spring retainer for biasing said brake ring support towards said cover assembly against said camming surface of said control dial.

18. The fishing reel according to claim 16 wherein:
guide holes of said brake ring support are defined by said central dial interfacing members of said brake ring support.

19. A fishing reel comprising:
a frame having a first side, said first side defining a plurality of frame locking structures;
a cover assembly having an inside surface and an outside surface, said inside surface adjacent said first side of said frame;
a brake spool cover secured to said inside surface of said cover assembly, said brake spool cover having an inner side;
said brake ring support adjacent said inner side of said brake spool cover, said brake ring support axially positionable with regard to said brake spool cover, said brake ring support defining a plurality of guide holes; and
a slide spring retainer defining prongs that extend towards said cover assembly, said prongs received in said guide holes of said brake ring support.

20. The fishing reel according to claim 19 wherein:
said cover assembly defines a control dial orifice;
said brake ring support defining control dial interfacing members; and
further comprising a control dial received in said control dial orifice of said cover assembly, said control dial defining a camming surface that engages said control dial interfacing members of said brake ring support for axially displacing said brake ring support and an attached brake ring.

21. The fishing reel according to claim 20 further comprising:
slide springs on said prongs of said slide spring retainer for biasing said brake ring support towards said cover assembly against said camming surface of said control dial.

22. The fishing reel according to claim 20 wherein:
said guide holes of said brake ring support are defined by said control dial interfacing members of said brake ring support.

23. The fishing reel according to claim 19 further comprising:
a lock ring having an inner surface, an outer surface, and a width between said inner surface and said outer surface, said inner surface defining a plurality of inside lock ring locking structures for locking communication with said frame locking structures, said outer surface defining outer lock ring locking structures.

24. The fishing reel according to claim 23 wherein:
said outside surface of said cover assembly defines cover locking structures for locking engagement with said outer lock ring locking structures of said lock ring.

25. The fishing reel according to claim 23 wherein:
said inner surface of said lock ring is affixed to said first side of said frame;
said inside surface of said cover assembly is affixed to said outer surface of said lock ring.

26. The fishing reel according to claim 23 wherein:
said lock ring is comprised of a non-corrosive material.

27. The fishing reel according to claim 23 wherein:
one of said frame locking structures and said inside lock ring locking structures has a height, a length, and a receiving side, wherein said receiving side defines a locking member receiving indentation for receiving a horizontal locking member.

28. The fishing reel according to claim 23 wherein:
one of said frame locking structures and said inside lock ring locking structures is locking members having an height, a width and an engaging side, said engaging side defining a horizontal member sized to be received in a locking member receiving indentation of the other of said frame locking structures and said inside lock ring locking structures when said lock ring is rotated in a first direction.

29. The fishing reel according to claim 23 wherein:
said inner surface of said lock ring defines tab receiving channels that run from said outer surface to said inner surface of said lock ring, said inner surface further defining a tab receiving area in communication with said tab receiving channels.

30. The fishing reel of claim 23 wherein:
said lock ring includes a locking lever to facilitate ease of rotation of said lock ring.

31. The fishing reel according to claim 23 further comprising:
a first lock ring retaining tab and a second lock ring retaining tab affixed to said first side of said frame for securing said lock ring to said frame.
